(19) United States
(12) Patent Application Publication
(10) Pub. No.: US 2005/0166451 A1
(43) Pub. Date: Aug. 4, 2005

(54) Breathable plant container

(76) Inventor: Mieczyslaw Michel Stachnik, Luxembourg (LU)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/886,254

(22) Filed: Jul. 7, 2004

Related U.S. Application Data
(60) Provisional application No. 60/485,796, filed on Jul. 9, 2003.

(51) Int. Cl. A01G 9/02

(52) U.S. Cl. 47/65.7; 47/67

(57) ABSTRACT

A breathable plant container is provided that includes a hollow vessel having an opening through which planting soil can be inserted into the hollow portion of the vessel and through which a plant growing in the soil can grow out of the vessel. The hollow vessel has a wall comprised of a synthetic microporous sheet material selected from the group of flash-spun plexifilamentary fabrics, spunbonded/meltblown/spunbonded (“SMS”) fabrics, and microporous film laminates. The wall of the hollow vessel preferably has an air porosity less than 200 seconds/100 cm³, a moisture vapor transmission rate of at least 300 g/m²/day, and a hydrostatic head of at least 20 cm. The hollow vessel may have a first compartment separated from a second compartment by a synthetic, moisture vapor permeable membrane that resists the passage of water such that water added to the second compartment can keep moist soil added to the first compartment.

### FIELD OF THE INVENTION

This invention relates to a breathable plant container. More particularly, the invention relates to a plant container comprised of synthetic microporous sheet, such as a microporous nonwoven fabric or a microporous film laminate, that is waterproof, but is also air and moisture vapor permeable.

### BACKGROUND OF THE INVENTION

Plants are commonly grown in various types of containers including clay and plastic pots. Plant containers comprised of flexible materials that can be hung from vertical surfaces are also known. French Patent Application No. 2,680,626 discloses a vertical arrangement of plant containers with individual irrigation tubes wherein the containers are made of PVC sheeting. U.S. Pat. No. 4,149,339 discloses a hanging plant holder comprised of superposed and sealed vinyl plastic sheets that are sealed together to form an upper plant pocket and a lower water reservoir. United Kingdom Patent Application No. GB 2,070,403 discloses a hanging plant holder comprised of polyethylene sheets with plant pockets that each have an irrigation tube and a drainage hole. Unfortunately, the impermeability of plastic vinyl and polyethylene sheets to air, moisture and water make such containers damaging to long-term plant health, especially were the amount of soil held by the container is small.

Japanese Patent Application No. Kokai 2000-69854 discloses a hanging planter bag comprised of plastic sheet, a laminate or a woven or nonwoven fabric covered with a waterproofing agent, with air permeable and water-retaining materials being preferred. The opposite sides of the planter bags may be sealed so as to create separate soil compartments and water channels with passages to allow water in the water channels to pass into soil in the soil compartment. Drain holes in the bottom of the bags permit excess water to drain from the bag.

There is still a need for a flexible plant container that does not leak water such that it can be used in both inside and outside spaces. There is a further need for a plant container that is made of a material that allows air and moisture to pass such that planting soil in the container can be maintained in an aerated condition that is beneficial to plant health. There is a further need for a flexible plant container having a self-regulating irrigation system that keeps soil contained in the container moist but not dripping wet. There is also a need for plant containers made of strong yet flexible materials that can be formed in a variety of shapes using conventional vertical or horizontal pouch producing equipment.

### BRIEF DESCRIPTION OF THE DRAWINGS

A more thorough explanation of the invention will be provided in the detailed description of the preferred embodiments of the invention in which reference will be made to the following drawings:

FIG. 1 is a perspective view of a breathable plant container according to one preferred embodiment of the invention.

FIG. 2 is a perspective view of a breathable plant container according to another embodiment of the invention.

FIG. 3 is a perspective view of a breathable plant container according to another embodiment of the invention.

FIG. 4 is an exploded perspective view of a breathable plant container according to another embodiment of the invention.

FIG. 5 is a perspective view showing a number of vertically hung breathable plant containers according to the invention.

### TEST METHODS

In the description and claims that follow, the following test methods were employed to determine various reported characteristics and properties. ASTM refers to the American Society for Testing and Materials, TAPPI refers to the Technical Association of Pulp and Paper Industry, DIN refers to the Deutsches Institut für Normunge e.V. (German Institute for Standards), and ISO refers to the International Organization for Standardization.

Air Porosity is a measure of the permeability of the sheet material for gaseous materials. In particular, it is a measure of how long it takes for a volume of gas to pass through an area of material wherein a certain pressure gradient exists. Air porosity is measured in accordance with TAPPI T-4600M-88 using a Lorentzen & Wettre Model 121 D Densometer. This test measures the time required for 100 cubic centimeters of air to be pushed through a 2.87 cm diameter sample (having an area of 6.45 cm²) under a pressure of approximately 1.21 kPa (12 cm or 4.9 inches of water). This method is commonly referred to as the Gurley Hill Porosity method, and the result is expressed in seconds or seconds per 100 cm³, which is frequently referred to as Gurley Seconds.

Moisture Vapor Transmission Rate (MVTR) was determined by ASTM E398-83 (which has since been withdrawn), which is hereby incorporated by reference. MVTR is reported in g/m²/24 hr. ASTM E398-83 (the “LYSSY” method) is based on a pressure gradient of 85% relative humidity (“wet space”) vs. 15% relative humidity (“dry space”) at a temperature of 23° C. The LYSSY method measures the moisture diffusion rate for just a few minutes and under a constant humidity delta, which measured value is then extrapolated over a 24 hour period.

Hydrostatic Head is a measure of the resistance of the sheet to penetration by liquid water under a static load. A 7 inch×7 inch (17.78 cm×17.78 cm) sample is mounted in a Textest FX 3000 Hydrostatic Head Tester (manufactured by Texttest Instruments, Switzerland). Water is pumped against one side of a 100 cm² section of the sample at a rate of 60+/−3 cm/min until three areas of the sample are penetrated by the water. The hydrostatic pressure is measured in inches, converted to SI units and given in centimeters of water. The test generally follows DIN-EN 20811.

Tensile Strength was determined by DIN EN ISO 1924-2, which is hereby incorporated by reference, with the following modifications. In the test, a 2.54 cm by 20.32 cm (1 inch by 8 inch) sample was clamped at its opposite ends. The clamps were attached 12.7 cm (5 in) from each other on the sample. The sample was pulled steadily at a speed of 5.08 cm/min (2 in/min) until the sample broke. The force at break was recorded in Newtons/cm as the breaking tensile strength.

Seam Tensile Strength was determined by ISO 13935-2: 1999(E) part 2, which is hereby incorporated by reference, and is reported in units of Newtons. The method determines the maximum force to seam rupture using the grab tensile test method. For the grab tensile test, the dimensional clamping area of the fabric is 25 mm by 25 mm, the sample of fabric has a width of 100 mm and a length of 250 mm and the distance between the clamps is 100 mm. The grab tensile strength of the seam is measured at an extension rate of 50 mm/min.

### DEFINITIONS

The term “polymer” as used herein, generally includes homopolymers, copolymers (such as for example, block, graft, random and alternating copolymers), terpolymers, and blends and modifications thereof. Furthermore, unless otherwise specifically limited, the term “polymer” shall include all possible geometrical configurations of the material. These configurations include isotactic, syndiotactic and random symmetries.

The term “polyolefin” as used herein, is intended to mean any of a series of largely saturated open chain polymeric hydrocarbons composed only of carbon and hydrogen atoms. Typical polyolefins include polyethylene, polypropylene, polymethylpentene and various combinations of the ethylene, propylene, and methylpentene monomers.

The term “polyethylene” as used herein is intended to encompass not only homopolymers of ethylene, but also copolymers wherein at least 85% of the recurring units are ethylene units.

The term “polypropylene” as used herein is intended to embrace not only homopolymers of propylene but also copolymers wherein at least 85% of the recurring units are propylene units.

The term “PTFE” as used herein is intended to embrace homo and copolymers of polytetrafluoroethylene and other fluorinated polymers.

The term “plexifilamentary” means a three-dimensional integral network of a multitude of thin, ribbon-like, film-fibril elements of random length and with a mean film thickness of less than about 4 microns and with a median fibril width of less than about 25 microns. In plexifilamentary structures, the film-fibril elements are generally coextensively aligned with the longitudinal axis of the structure and they intermittently unite and separate at irregular intervals in various places throughout the length, width and thickness of the structure to form a continuous three-dimensional network.

The term “flash-spun plexifilamentary fabric” means a thermally bonded web of flash-spun plexifilamentary film-fibrils that have sub micron-size passageways extending from one surface of the fabric to the other.

The term “meltblown fibers” as used herein, means fibers formed by extruding a molten thermoplastic polymer through a plurality of fine, usually circular, capillaries as molten threads or filaments into a high velocity gas (e.g. air) stream. The high velocity gas stream attenuates the filaments of molten thermoplastic polymer material to reduce their diameter to between about 0.5 and 10 microns. Meltblown fibers are generally discontinuous fibers. Meltblown fibers carried by the high velocity gas stream are normally deposited on a collecting surface to form a web of randomly dispersed fibers.

The term “spunbond” as used herein means a bonded sheet of meltspun fibers which are formed by extruding molten thermoplastic polymer material as filaments from a plurality of fine, usually circular, capillaries of a spinnerette. Meltspun fibers are generally continuous and have an average diameter of greater than about 5 microns.

The term “nonwoven fabric, sheet or web” as used herein means a structure of individual fibers or threads that are positioned in a random manner to form a planar material without an identifiable pattern, as in a knitted fabric.

The term “microporous film” as used herein means polymer film characterized by micron-sized pores (invisible to the naked eye) that allow moisture to pass through while shutting out water droplets. Microporous films are normally comprised of a polyolefin, such as polyethylene or polypropylene, but may also be comprised of more durable polymers such as PTFE. Polyolefin films are stretched in both directions (the machining and cross directions) for improved permeability and greater control over pore size. The biaxial stretching process gives the film greater tensile strength in the transverse direction and greater tear strength than uniaxial-stretched films. Many microporous films are made out of a polyolefin with a fine filler material, such as calcium carbonate, which through the film extrusion and film stretching, becomes a breathable microporous film. Mircoporous films are permeable to moisture while being substantially impermeable to water droplets. Microporous films transmit air, gas and vapor, but still act as a barrier to water.

### DETAILED DESCRIPTION

Reference will now be made in detail to the presently preferred embodiments of the invention, examples of which are illustrated below. The invention is directed to a breathable plant container. The breathable plant container of the invention comprises a hollow vessel having an opening therein through which planting soil can be inserted into the hollow portion of the vessel and through which a plant growing in the soil can grow out of the vessel. The hollow vessel has a wall comprised of a synthetic microporous sheet material having micropores of a size that permit the passage of air and moisture vapor but that resists the passage of water. The microporous sheet material is selected from the group of flash-spun plexifilamentary fabrics, spunbonded/meltblown/spunbonded (“SMS”) fabrics, and microporous film laminates.

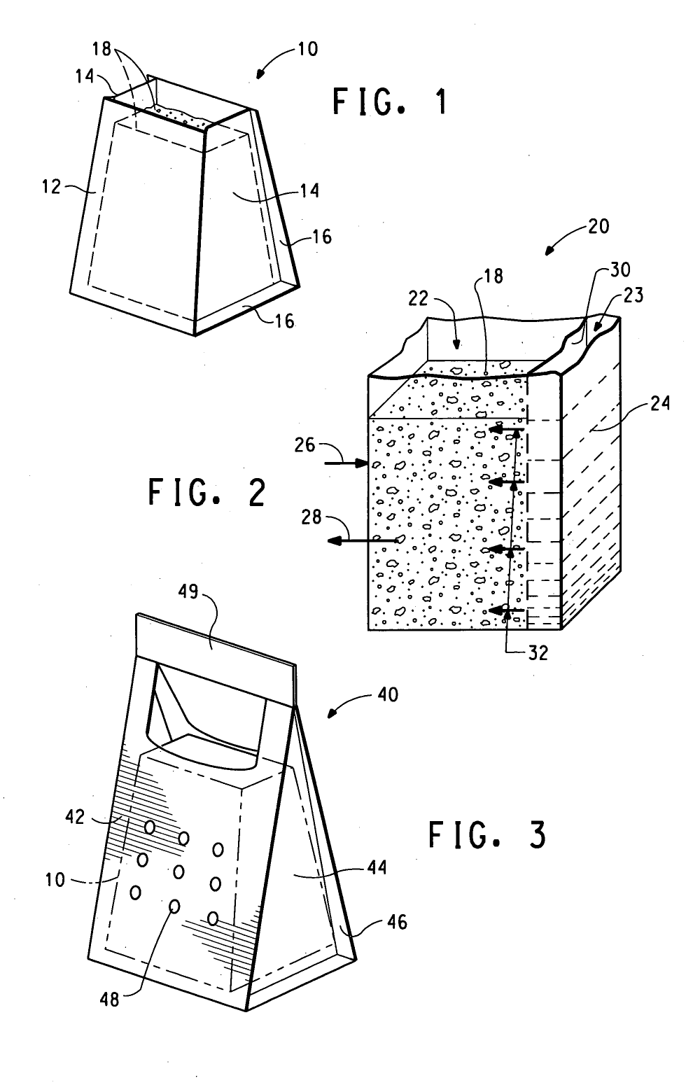

According to the embodiment of the invention illustrated in FIG. 1, the breathable plant container comprises a hollow vessel 10 comprised of a synthetic microporous sheet material. In the embodiment of the invention shown in FIG. 1, the hollow vessel has a panel 12 that forms the front, bottom and back of the container, and opposite side panels 14 that are joined to the panel 12 along seams 16. The seams 16 are water tight and are preferably formed by thermal bonding, sonic welding, adhesive bonding, or by other know means. Seams formed by thermally fusing overlapping portions of the panels 12 and 16 are preferred. The vessel 10 has an opening in its upper half, preferably at or near its top, through which soil 18 can be introduced into the vessel. Alternative configurations of the hollow vessel 10 exist that are within the scope of the invention, such as a vessel formed by folding a single panel over on itself and sealing seams on opposite sides, or a multi-sided vessel formed of multiple panels joined together along water-tight seams.

The synthetic microporous sheet material has micropores that permit the passage of air and moisture vapor, but that resist the passage of water. By using a synthetic material, rotting of the vessel is avoided. The synthetic microporous sheet material of the vessel 10 is one that resists the passage of water and is waterproof under normal operating conditions. At atmospheric operating conditions, the synthetic microporous sheet material helps maintain pressure equalization by continuously allowing the exchange of contained gases with the surrounding air environment. The synthetic microporous sheet material that forms the walls of the hollow vessel 18 preferably has an air porosity value of less than 200 seconds/100 cm³, a moisture vapor transmission rate of at least 300 g/m²/day, and a hydrostatic head of at least 20 cm. More preferably, the synthetic microporous sheet material that forms the walls of the hollow vessel 18 has an air porosity value of less than 25 seconds/100 cm³, a moisture vapor transmission rate of at least 1200 g/m²/day, and a hydrostatic head of at least 30 cm. A vessel comprised of a synthetic microporous sheet material exhibiting such properties allows oxygen to diffuse through the container into soil held within the container and also permits carbon dioxide in soil held within the container to diffuse out through the container. This “breathing” through the container contributes greatly to the health of plants grown in soil held within the container, especially where the volume of soil is not large in proportion to the size of be plant being grown. A vessel comprised of a synthetic microporous sheet material exhibiting the above properties also keeps water from leaking through the vessel walls. This is especially important when the plant container is used indoors.

The synthetic microporous sheet material that forms the walls of the hollow vessel of the plant container of the invention is a flash-spun plexifilamentary fabric, an SMS sheet material or a microporous film laminate. Preferably, the flash-spun plexifilamentary fabric is comprised of a thermally bonded web of polyolefin polymer plexifilamentary film fibrils, and more preferably, the polyolefin polymer is polyethylene. Bonded flash-spun polyolefin plexifilamentary fabrics offer a unique combination of micro-porous web characteristics and mechanical strength in a nonwoven fabric with a unitary construction. A preferred polyolefin plexifilamentary sheet material is Tyvek® flash-spun polyethylene fabric made by E. I. du Pont de Nemours and Company. A preferred style is Tyvek 3562 B, having a basis weight of 60 g/m², a porosity of 110 seconds/100 cm³, an MVTR of 1260 g/m²/24 h, a hydrostatic head of 170 cm, and a tensile strength of 33 N/cm.

Preferably, the SMS sheet material has a meltblown layer comprised of polypropylene or polyester meltblown fibers or combinations thereof that are sandwiched between two spunbonded layers that are each comprised of polypropylene, polyethylene or polyester meltspun fibers or combinations thereof. The SMS fabric may alternatively be an SMMS, which includes two melt-blown layers sandwiched between two spun-bonded layers, or other combinations that include one or more layers of meltblown fibers between spunbonded layers. A preferred SMS fabric is Daltex Roofshield sold by the Proctor Group of Perthshire, United Kingdom, having a basis weight 250 g/m², a porosity of 6 seconds/100 cm³, an MVTR of 1935 g/m2/24 h, a hydrostatic head of 220 cm, and a tensile strength of 47 N/cm.

The preferred microporous film laminates are laminates of a microporous film and a nonwoven fabric that exhibit good mechanical strength and durability. Microporous film laminates provide excellent air and water vapor permeability and very good water resistance. Preferably, the microporous film of the laminate is a biaxially oriented polyolefin microporous film, such as a polypropylene microporous film, but other microporous films such as PTFE microporous films may also be utilized. The nonwoven layer or layers of the laminate are preferably spunbonded nonwovens, such as spunbonded polypropylene or polyester, but other nonwoven fabrics such as spunlaced fabrics, carded nonwovens, airlaid nonwovens and needle felts may also be utilized. A preferred microporous laminate is a laminate of a spunbonded nonwoven/microporous film/spunbonded nonwoven, such as a microporous polypropylene film with two low basis weight polypropylene nonwovens on each side of microporous film. One microporous laminate that can be used in the invention is Tyvek® Universal 5806X, which is a spunbonded polypropylene/microporous polypropylene film/spunbonded polypropylene laminate having a basis weight of 135 g/m², an average porosity of 24 seconds/100 cm³, an MVTR of 1875 g/m²/24 hr, a hydrostatic head of 600 cm, and a tensile strength of 25 N/cm.

The synthetic microporous sheet material that forms the walls of the hollow vessel of the plant container may be laminated to one or more other woven, nonwoven, or microporous film layers. For example, the microporous sheet material may be comprised of two or more of the microporous sheet materials described above laminated to each other. When the synthetic microporous sheet material includes two or more layers made of different polymers with different melting temperatures, the seams of the hollow vessel can be more readily formed by thermal welding or bonding. Examples of laminates than can be utilized include a laminate of a polyolefin microporous film attached to a layer of polyolefin or polyester SMS or spunbonded fabric, a laminate of a polyolefin microporous film sandwiched between layers of polyolefin or polyester spunbonded or SMS fabric, a laminate of a polyolefin flash-spun plexifilamentary nonwoven and a polypropylene spunbonded fabric, or a laminate of a polyolefin flash-spun plexifilamentary nonwoven and a polyolefin or polyester spunbonded or SMS fabric.

According to a preferred embodiment of the invention, the synthetic microporous sheet material has a tensile strength of at least 10 N/cm. A sheet material having such a tensile strength is sufficiently strong to support damp soil and plants growing from such soil. More preferably, the synthetic microporous sheet material has a tensile strength of at least 30 N/cm. It is further preferred that the overlapping thermally fused seam sections have a seal strength of at least 10 N and more preferably of at least 30 N. This seal strength keeps the vessel from bursting under the weight of damp soil held within the planter. The Tyvek® 3562 polyethylene flash-spun plexifilamentary fabric discussed above has a tensile strength of 33 N/cm, and a 1 cm wide overlapping seam that has been thermally bonded at a temperature of between 125 and 130° C. using a 3 mm wide welding wire has an average seal strength of about 70 N.

According to another preferred embodiment of the invention the hollow vessel of the breathable plant container of the invention has a first compartment and a second compartment, with the first compartment being separated from the second compartment by a synthetic, moisture vapor permeable membrane that resists the passage of water. The first compartment is in communication with the opening through which planting soil can be inserted into the hollow portion of the vessel within said first compartment, and the second compartment has an opening through with water can be added to the second compartment. When water is added to the second compartment, moisture can pass through the moisture vapor permeable membrane and into soil that has been inserted in said first compartment.

In the embodiment of the invention shown in FIG. 2, the container 20 has a first compartment 22 into which planting soil 18 can be inserted. The container 20 also has a second compartment 23 for holding water. The first compartment is separated from the second compartment by a moisture vapor permeable, liquid impermeable membrane 30 through which moisture 32 can pass from the reservoir of the second compartment 23 and into the soil 18 in the first compartment 22. The moisture vapor permeable, liquid impermeable membrane is preferably a synthetic microporous nonwoven sheet material having micropores that are large enough to permit the passage of moisture vapor but that are small enough to resist the passage of liquid water. Alternatively, the membrane 30 may be comprised of a microporous film laminated to a supporting material such as a spunbonded nonwoven, or of a moisture vapor permeable and liquid impermeable unitary film such as a hydrophilic thermoplastic polyurethane film, a polyether ester block copolymer film, or a polyether polyamide block copolymer film.

According to the preferred embodiment of the invention, the moisture vapor permeable membrane between the first and second compartments of the hollow vessel exhibits a moisture vapor transmission rate of at least 800 g/m²/day, and a hydrostatic head of at least 10 cm. In a preferred embodiment of the invention the moisture vapor permeable, liquid impermeable membrane is Tyvek® 1060B flash-spun polyethylene fabric made by DuPont having a basis weight of 61 g/m², a hydrostatic head of 155 cm, and a moisture vapor transmission rate of 1750 g/m²/24 hr. In the embodiment of the invention shown in FIG. 2, the soil 18 is maintained in optimum condition for growing because carbon dioxide 28 is able to exit the soil 18 through the exterior walls of the first compartment 22 of the container 20, oxygen 26 is able to enter the soil through the exterior walls of the first compartment 22 of the container 20, and moisture vapor 32 is able to enter the soil through the moisture vapor permeable membrane 30.

According to a preferred embodiment of the invention, the breathable plant container of the invention has a support pouch that holds and surrounds the hollow vessel. The support pouch has an opening that is aligned with the opening of the hollow vessel, and the support pouch preferably consists essentially of a synthetic fibrous nonwoven fabric material. The support pouch has an interior surface in contact with the wall of the hollow vessel and an opposite exterior surface. The support pouch has air passages that permit the passage of air and moisture vapor between the wall of the hollow vessel and the exterior surface of the support pouch.

In the embodiment of the invention shown in FIG. 3, a support pouch 40 surrounds and holds a hollow vessel like the vessel 10 shown in FIG. 1. In the embodiment of the invention shown in FIG. 3, the support pouch 40 has a panel 42 that forms the front, bottom and back of the container, and opposite side panels 44 that are joined to the panel 12 along seams 46. The seams 46 are preferably formed by thermal bonding, sonic welding, adhesive bonding, stitching, or by other know means. Seams formed by thermally fusing overlapping portions of the panels 42 and 46 are preferred. The pouch 40 has an opening at or near its top through which a hollow vessel 10 can be inserted or removed from the pouch 40 and through which soil and water can be fed into the hollow vessel 10. Holes 48 may be added to the front, back, sides or bottom of the support pouch so as to facilitate the passage of air into and out of the hollow vessel 10 held within the support pouch. The support pouch 40 may include a handle 49 from which the support pouch can be held or hung from a hook. Alternative configurations of the support pouch 40 exist that are within the scope of the invention, such as a pouch formed by folding a single panel over on itself and sealing seams on opposite sides, or a multi-sided pouch.

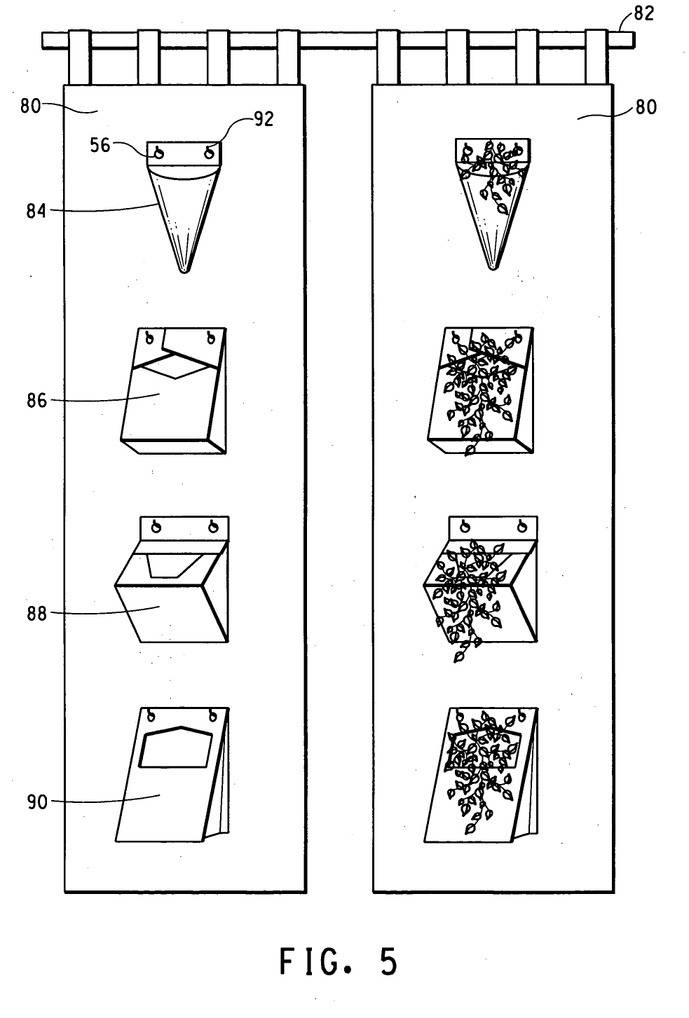

A number of alternative configurations for the support pouch are shown in FIG. 5. The pouch 84 is a cone shaped pouch with fastening holes 56 that can be hung on hooks 92 or other fasteners. The pouches 86, 88 and 90 are another three alternative configurations for the support pouch. It is anticipated that the support pouch can be hung from any inclined or vertical surface such as a fabric panel 80 hanging from a rod 82, a fence or a wall. It is also anticipated that any of the support pouches 84, 86, 88 and 90 can accommodate a hollow soil holding vessel like the vessel 10 described above with reference to FIG. 1. Preferable the support pouch and hollow soil holding vessel are separate from each other to permit easier insertion and removal of plants. However, it is also anticipated that the hollow vessel and the support pouch could be connected to each other by thermal welding, sonic bonding, adhesive bonding or the like. As discussed above, the hollow vessel and the support pouch can be combined by producing a vessel from a microporous sheet material that has been laminated with a support fabric such as a spunbonded polyolefin or polyester.

The support pouch is preferably comprised of a fabric with pores that comprise the support pouch air passages. According to a preferred embodiment of the invention, the support pouch is comprised of a synthetic nonwoven material that is open to the passage of air and has a tensile strength of at least 15 N/cm. The synthetic nonwoven is preferably a spunbonded polyolefin, and is more preferably spunbonded polypropylene. A preferred spunbonded polypropylene is Typar® 3276-B spunbonded polypropylene made by DuPont having a basis weight of 90 g/m², a tensile strength of 39 N/cm, and a very open structure.

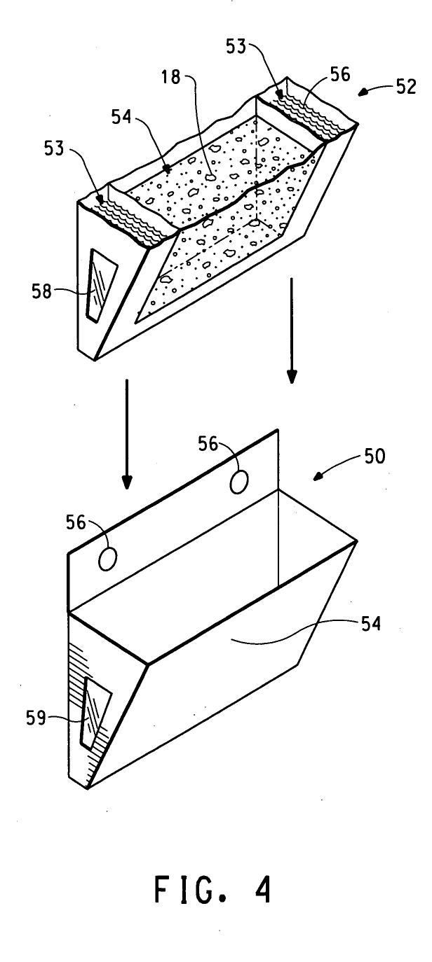

In an alternative embodiment of the invention shown in FIG. 4, a hollow vessel 52 is formed with a first soil-holding compartment 54 and a second water-holding compartment 53 on the sides and bottom of the compartment 54. This arrangement provides for a moisture vapor permeable, water impermeable membrane between the water-holding and soil-holding compartments of the vessel 52 with greater surface area than in the embodiment of the invention shown in FIG. 2. The hollow vessel 52 is held by the support pouch 50 which can be hung via the holes 56 on hooks located on a vertical or inclined surface. In the embodiment of the invention shown in FIG. 4, the hollow vessel 52 includes a clear panel 58 through which the level of the water in the water-holding compartment 53 can be observed. A corresponding clear panel 59 in the support pouch 50 permits the water level within the hollow vessel 52 to be view from outside of the support pouch. Alternatively, the moisture level in the soil can be monitored using a conventional soil moisture sensor.

Both the hollow vessel and support pouch portions of the plant container of the invention, as described above, can be manufactured using known flexible packaging horizontal pouch making machinery. For example, both the hollow vessel and the support pouch can be manufactured using the B-1600 or B-2500 horizontal pouch machines manufactured by Bossar of Barcelona, Spain. Other suitable high speed pouch making machines are available from Amcor Limited of Melbourne, Australia, and Totani Corporation of Kyoto, Japan.

The following non-limiting example is intended to illustrate the invention and not to limit the invention in any manner.

### EXAMPLE

The hollow vessel portion of a breathable plant container was prepared from a sheet of Tyvek 3562 B flash-spun plexifilamentary fabric, having a basis weight of 60 g/m². A trapezoid-shaped piece of the fabric was cut having a 25.5 cm long base edge, a height of 38 cm, and a 19 cm long top edge that was parallel to the base edge. The trapezoid-shaped piece was folded in half along a line that was parallel to the base and top edges. Two triangle-shaped side portions of the fabric, where there was no overlap along the opposite sides of the wider half of the folded piece, were each folded over along the edge of the overlapped portion of the piece. The folded trapezoid-shaped piece was opened slightly and the lateral free edge of each of the two folded triangle-shaped side portions were overlapped by about 1 cm with the respective side edges of the narrower half of the trapezoid-shaped piece. Each overlapping portion was heat welded at temperature between 125° and 130° C. for 3 seconds using a 3 mm wide welding wire of a type ZI-400 heat welding machine for plastic materials manufactured by ZEMAT, of Lodz, Poland. The water resistance of the welded hollow vessel was checked by filling it completely with water for 24 hours and no water escaped.

A supporting pouch was manufactured from two pieces of Typar 3267-B spunbonded polypropylene, having a basis weight of 90 g/m². A first piece that formed the front, sides and bottom of the pouch was heat welded and sewn to a second rectangular piece that formed the back of the pouch. The pocket of the pouch was 190 mm wide, about 160 mm deep, and extended about 50 mm out from the back. The support pouch and the hollow vessel were sewn together around the top openings of the hollow vessel and the support pouch pocket.

A green houseplant was transplanted into the hollow vessel and loose soil was then filled into the empty portions. The plant container was hung on a vertical interior house wall and the plant was then watered through the opening one time per week. The soil remained moist and the plant grew well over a one year period.

Although particular embodiments of the present invention have been described in the foregoing description, it will be understood by those skilled in the art that the invention is capable of numerous modifications, substitutions and rearrangements without departing from the spirit or essential attributes of the invention. Reference should be made to the appended claims, rather than to the foregoing specification, as indicating the scope of the invention.

1. A breathable plant container comprising:
a hollow vessel having an opening therein through which planting soil can be inserted into the hollow portion of the vessel and through which a plant growing in the soil can grow out of the vessel, said vessel having a wall comprised of a synthetic microporous sheet material having micropores of a size that permit the passage of air and moisture vapor but that resists the passage of water, said synthetic microporous sheet material selected from the group of flash-spun plexifilamentary fabrics, spunbonded/meltblown/spunbonded (“SMS”) fabrics, and microporous film laminates.

2. The breathable plant container of claim 1 wherein the synthetic microporous sheet material is a flash-spun plexifilamentary fabric is comprised of polyolefin polymer plexifilamentary film fibrils.

3. The breathable plant container of claim 2 wherein the polyolefin polymer is polyethylene.

4. The breathable plant container of claim 1 wherein the synthetic microporous sheet material is SMS fabric.

5. The breathable plant container of claim 4 wherein the SMS fabric has a meltblown layer comprised of polypropylene or polyester meltblown fibers or combinations thereof, said meltblown layer being sandwiched between two spunbonded layers that are each comprised of polypropylene, polyethylene or polyester meltspun fibers or combinations thereof.

6. The breathable plant container of claim 1 wherein the wall of said vessel has an air porosity less than 200 seconds/100 cm³, a moisture vapor transmission rate of at least 300 g/m²/day, and a hydrostatic head of at least 20 cm.

7. The breathable plant container of claim 1 wherein the wall of said vessel has an air porosity less than 25 seconds/100 cm³, a moisture vapor transmission rate of at least 1200 g/m²/day, and a hydrostatic head of at least 30 cm.

8. The breathable plant container of claim 1 wherein the wall of said vessel is comprised of multiple pieces of a thermally fusable, synthetic microporous sheet material that are joined to each other by overlapping thermally fused seam sections.

9. The breathable plant container of claim 8 wherein the synthetic microporous sheet material has a tensile strength of at least 10 N/cm and wherein the overlapping thermally fused seam sections have a seal strength of at least 10 N/cm.

10. The breathable plant container of claim 1 wherein said hollow vessel has a first compartment and a second compartment, said first compartment being separated from said second compartment by a synthetic, moisture vapor permeable membrane that resists the passage of water, said first compartment being in communication with the opening through which planting soil can be inserted into the hollow portion of the vessel within said first compartment, said second compartment having an opening through with water can be added to the second compartment such that when water is added to the second compartment, moisture can pass through the moisture vapor permeable membrane into soil that has been inserted in said first compartment.

11. The breathable plant container of claim 10 wherein the synthetic, moisture vapor permeable membrane between the first and second compartments of said hollow vessel is comprised of a synthetic microporous sheet material that exhibits a moisture vapor transmission rate of at least 800 g/m²/day, and a hydrostatic head of at least 10 cm.

12. The breathable plant container of claim 1 further comprising a support pouch that holds and surrounds said hollow vessel, said support pouch having an opening that is aligned with the opening of said hollow vessel, said support pouch comprised of a fabric material, said support pouch having an interior surface in contact with the wall of the hollow vessel and an opposite exterior surface, and said support pouch having air passages that permit the passage of air and moisture vapor between the wall of the hollow vessel and the exterior surface of the support pouch.

13. The breathable plant container of claim 12 wherein the support pouch is made of a synthetic nonwoven fabric with pores that comprise the support pouch air passages, said synthetic nonwoven fabric being open to the passage of air and having a tensile strength of at least 15 N/cm.

14. The breathable plant container of claim 12 wherein the hollow vessel and the support pouch are integrally formed from a laminate of a microporous sheet material and another fabric material.

15. The breathable plant container of claim 12 wherein the support pouch has at least one fastener for hanging the plant container from a vertical surface.

16. A breathable plant container comprising:
a hollow vessel having an opening therein through which planting soil can be inserted into the hollow portion of the vessel and through which a plant growing in the soil can grow out of the vessel, said vessel having a wall comprised of a synthetic microporous sheet material having micropores of a size that permit the passage of air and moisture vapor but that resists the passage of water,
said hollow vessel having a first compartment and a second compartment, said first compartment being separated from said second compartment by a synthetic, moisture vapor permeable membrane that resists the passage of water, said first compartment being in communication with the opening through which planting soil can be inserted into the hollow portion of the vessel within said first compartment, said second compartment having an opening through with water can be added to the second compartment such that when water is added to the second compartment, moisture can pass through the moisture vapor permeable membrane into soil that has been inserted in said first compartment.

17. The breathable plant container of claim 16 wherein the synthetic, moisture vapor permeable membrane between the first and second compartments of said hollow vessel is comprised of a nonwoven material, and exhibits a moisture vapor transmission rate of at least 800 g/m²/day, and a hydrostatic head of at least 10 cm.

18. A breathable plant container comprising:
a hollow vessel having an opening therein through which planting soil can be inserted into the hollow portion of the vessel and through which a plant growing in the soil can grow out of the vessel, said hollow vessel having a wall consisting essentially of a synthetic microporous sheet material having micropores of a size that permit the passage of air and moisture vapor but that resists the passage of water, wherein the wall of said vessel has an air porosity greater than 20 seconds/100 cm³, a moisture vapor transmission rate of at least 600 g/m²/day, and a hydrostatic head of at least 20 cm,
said hollow vessel has a first compartment and a second compartment, said first compartment being separated from said second compartment by a synthetic, moisture vapor permeable membrane that resists the passage of water, said first compartment being in communication with the opening through which planting soil can be inserted into the hollow portion of the vessel and into said first compartment, said second compartment having an opening through with water can be added to the second compartment such that when water is added to the second compartment the second compartment acts as a reservoir and moisture can pass through the moisture vapor permeable membrane into soil that has been put in said first compartment,
a support pouch that holds and surrounds said hollow vessel, said support pouch having one or more openings aligned with the openings of said hollow vessel through which soil and water can be added to the first and second compartments of the hollow vessel, said support pouch comprised of a fibrous fabric material, said support pouch having an interior surface in contact with the wall of the hollow vessel and an opposite exterior surface, and said support pouch having air passages that permit the passage of air and moisture vapor between the wall of the hollow vessel and the exterior surface of the support pouch.

19. The breathable plant container of claim 18 wherein the support pouch consists essentially of a spunbonded polyolefin fabric with pores that comprise the support pouch air passages, said spunbonded polyolefin fabric having a tensile strength of at least 15 N/cm and being open to the passage of air, said support pouch having at least one fastener for hanging the plant container from a vertical surface.

20. The breathable plant container of claim 19 wherein the wall of the hollow vessel consists of flash-spun plexifilamentary fabric comprised of polyolefin polymer plexifilamentary film fibrils.
